(19) United States
(12) Patent Application Publication
(10) Pub. No.: US 2014/0343702 A1
(43) Pub. Date: Nov. 20, 2014

(54) Gospel Song Rearrangement and Player Platform

(71) Applicant: Mark Shia, Taipei (TW)

(72) Inventor: Mark Shia, Taipei (TW)

(21) Appl. No.: 13/898,446

(22) Filed: May 20, 2013

(51) Int. Cl. G06F 17/30

(52) U.S. Cl. CPC G06F 17/30778
USPC 700/94

(57) ABSTRACT

The purpose of this invention is to make available worship songs (in audio form) that have undergone song segmentation processing and to provide the consumer a platform to purchase, rearrange, and replay these segmented songs. The characteristic lies in the fact that the service platform contains a storage of numerous segmented songs, and at the appropriate time, can make available a software program used for song rearrangement and player so that the user can use that program to sign in, purchase, and access a database containing at least one purchased song, and to access a second database, connected to the first database, which manages information exchange between the user end and the service platform. At the user end, one signs in to use the song rearrangement/song player software program and to access the service platform.

### FIELD OF THE INVENTION

This invention involves a gospel song rearrangement and replay platform.

### DESCRIPTION OF PRIOR ARTS

Due to progress, songs which were previously difficult to distribute have now became more easily disseminated and used, causing the spread of the gospel to be speedier and wider than before, and also allowing the singing of gospel songs to be more flexible.

However, if gospel songs continue to depend on existing mediums of dissemination, consumers can only listen, but cannot flexibly sing along.

This is particularly true during church worship, when the parts of a gospel song in their audio form cannot be freely reconnected to each other, thus disallowing the church from flexibly rearranging the order of parts of the songs according to a designed worship arrangement.

For example, an original recorded gospel song may run its verse two times, and its chorus three times, and there may be a prelude, a postlude, and an interlude. But during church worship, one may want to sing the verse twice before proceeding with the chorus, and thereafter, skip the interlude and have the chorus be repeated more than three times to meet the needs of a particular worship.

Such a need cannot be met with an original track of a gospel song, unless the church resorts to a live band. But to proceed with the latter method involves the same type of hassle involved in early periods of time when gospel songs were being disseminated in the old-fashioned way, by manually playing it in front of live audiences.

On another level, apart from inflexibility, the most prominent problem of a band is that a song is never played the same exact way twice, and thus one cannot listen to the same exact music over and over and again. One also cannot listen to a live band at one's own leisure.

Because of these problems, this invention seeks to improve flexibility in worship by providing a platform by which songs that have undergone segmentation processing can be supplied to the consumer/user for easy rearrangement and replay, thus allowing flexible sing-alongs.

### SUMMARY OF THE INVENTION

### First

### Invention Technique

This invention provides a platform by which songs, in their audio form, that have undergone segmentation processing, i.e., “presegmented songs,” can be freely rearranged by the consumer and after the songs purchase, can be replayed.

To solve the aforementioned problems and to reach the goals of this invention, the technology of this invention involves a platform by which songs in their audio form can be rearranged and replayed. This includes:

A remote service platform (100)—accessible by sing-in authentication—where numerous original gospel song audio files (NP) and these songs in their segmented form (P) are stored, which platform, in turn, supplies multiple consumer ends (10) with software programs designed to rearrange songs and to replay the songs.

The special characteristic lies in:

The service platform (100) features a remote end with a storage of numerous segmented songs (P), and at the appropriate time, can supply the consumer end (10) with the necessary software program (F) used for song rearrangement and player so that the consumer end (10) can use that software program (F) to sign in, retrieve, and purchase into a database (1) containing at least one purchased segmented song (P); and a second database (2) which is connected to the first database (1) used to manage the exchange of information (M) with the user end (10).

A to the consumer end (10), it employs a authentication system (X) to trigger the song rearrangement and player software program (F) and/or to gain access to the service platform (100).

The aforementioned song rearrangement and player software program (F), consists of a authentication module (F1) which allows the consumer end (10), vis a vis a authentication system (X), access to said software program (F) and/or to sign in and gain entry into the service platform (100)

It also consists of an encryption storage module (F), connected to the authentication module (F1), which allows a presegmented song which had been retrieved to be stored in a distant location.

It also consists of an application module (F3), connected to both the authentication module (F1) and the encryption storage module (F2), that allows the consumer end (10) to proceed with rearrangement and replay of the presegmented song (P).

It also consists of a song purchasing module (F4), connected to both the authentication module (F1) and the encryption storage module (F2), that provides the consumer end (1), after it has gained entry into the service platform (100), to connect with the first and second database, so that the presegmented songs (P) can be retrieved and purchased.

As to the aforementioned song rearrangement and replay platform, said service platform (100), is established in the following remote location: an independent computer server or a computer server having a giant-scale storage capacity.

As to the aforementioned song rearrangement and replay platform, said information exchange (M) entails the information data (M1) sent from at least one consumer end (10), a song-purchase data (M3) sent from at least one consumer end (10), sign-in data (M4) from at least one consumer end (10), and sign-off data (M5) from at least one consumer end (10).

As to the song rearrangement and reply platform, its authentication system (X), it is a authentication hardware that includes a connection medium (X1) that can connect with the consumer end (10); and a storage area for encrypted accounts (X3) and another storage area (X4), which is electronically connected with the aforementioned connection medium and which can be connected to the song rearrangement and replay program (F), so that the consumer end (10) can be provided a main body (X2) to exercise its use of the song rearrangement and replay program (F).

The aforementioned connection medium (X1) can be any one of the following: USB, Mini USB, Micro USB, or Thunderbolt.

Stored within the aforementioned storage area (X4) are a song rearrangement and replay program (F) and the segmented song (P) that the consumer end (10) had purchased.

The aforementioned segmented song (P) is made up of the following: the main verse (P1) of the original song (NP), the chorus (P2) of the original song (NP), the interlude (P3) of the original song (NP), any free worship segmented (P4) in the original song (NP), the postlude (P3) of the original song (NP).

The aforementioned authentication system (X) is a authentication system that processes encrypted account passwords.

### Second

### Comparison with the Effects of a Prior Technology

1. This invention, through the interplay of a song rearrangement and replay program (F) and a service platform (100), allows the consumer, from the consumer end (1), to purchase a song that had undergone segmentation (P), and to use this presegmented song (P) for rearrangement and replay according to the consumer's needs and purposes. Because these presegmented songs (P), through the use of the song rearrangement and replay program, can be free rearranged, the user can freely modify the order of play and the number of times to be played the main verse of the song (P1), the chorus (P2), the interlude (P3), the free worship (P4), and the postlude (P5). If during a worship service, the song needs to be played again for listening or for singing along, the problem of being unable to duplicate any part of music is averted. The invention can also be used to replay the music for listening pleasure.

This invention, by way of an authentication system (X), prevents the unlawful dissemination and unauthorized use of the segmented song (P), because only through the authentication system (X) can the song rearrangement and replay program (F) and/or the service platform (100) be accessed.

Within this invention, when the authentication system (X) is by way of hardware, for each such authentication system (X) there will only be a single encrypted account number storage area (X3). Because of the uniqueness of this storage area, it is different from conventional digitally based music vending systems. It is difficult to pirate song. Even when not hooked up to the internet, there is an assurance that the segmented songs (P) used by this invention will not be pirated.

3. With this invention, because the segmented songs (P) used by the service platform (100) are produced from original recorded songs (NP), that is, the parts of these songs will undergo modification of their order and the times being played such that these modified songs are different from the original song (NP) will be produced, they become distinct from the original songs such that they do not conflict with the sale of the original songs, but in fact, could greatly enhance the artistic value of the original songs (NP).

### DETAILED DESCRIPTION OF THE PREFERRED IMPLEMENT

The actual implementations, based on the chart, are as follows:

FIG. 1 sets forth a diagram of the invention.

FIG. 2 sets forth a diagram of the original song and the segmented song.

FIG. 3 sets forth a diagram of the song rearrangement and replay program.

FIG. 4 sets forth a diagram of the detailed parts of the consumer end when it is connected to the service platform.

The chart illustrates a song rearrangement and reply platform, and it includes:

A remotely located service platform (100) that is accessible from the consumer end (10) which contains numerous original songs (NP) and numerous such songs in their segmented form (P) and which supplies a song rearrangement and replay program (F).

The characteristic lies in:

The service platform (100), which comprises of a remotely located storage of numerous songs that have undergone segmentation (P), and supplies at any given time a song rearrangement and replay program (F) for the consumer end (1), and can at the same time, through the song rearrangement and replay program (F), be accessed by the consumer end (10) so that a first database (1) containing segmented songs (P) can be purchased and retrieved.

A second database (2) which is connected to the first database (1) which can manage information exchange (M) with the consumer end (1);

This consumer end (10) employs an authentication system (X) to trigger the song rearrangement and replay program (F) and/or sign into the applications in the service platform (100).

In the process, through the interplay between the song rearrangement and replay program (F) and the service platform (100), the consumer by way of the consumer end (10), can proceed with the purchase of segmented songs (P). After the purchase, the consumer can use the application module (F3) in the song rearrangement and replay program (F) to rearrange the parts of the songs. For example, the consumer, based on the purpose of a particular worship, can start with the main verse of one song, play the chorus of the song twice after that, proceed with the interlude, move on to the main verse of the next song, proceed with free worship part of that song, go into the main verse of a third song, the chorus of that third song, and the postlude of that third song. All this is made possible because the parts of a these presegmented songs (P) can be rearranged freely through the song rearrangement and replay program (F) and replayed through the application module (F3), to achieve an effect that is different than that of the original song (NP). The user will find it very convenient to use. Thereafter, for the user's own listening pleasure, the rearranged song can be replayed without experiencing any inability to duplicate the desired music.

What is more, due to the authentication system (X), any unauthorized leak or piracy of the segmented songs (P) is prevented. This is accomplished because only through the verification system (X) can the song rearrangement and replay program (F) and the service platform (100) made accessible.

On the other hand, because the presegmented songs stored in the service platform (100) all originated from original songs (NP), the ratio and the number of times of play for the parts of the songs will be different than the original songs (NP). These distinctive qualities of the rearranged songs will avert any unfavorable conflicts on the market, while at the same time, greatly enhancing the artistic value of these original songs (NP).

Furthermore, because rearrangement of songs can only be accomplished through the song rearrangement and replay program (F), due to the fact that the presegmented songs (P) can only be read by the song rearrangement and replay program (F), thus the file type of the presegmented song (P) will different from the ordinary file type used for audio files. Therefore, coupled with the use of the authentication system (X), a double layer of protection is afforded to the author of the original song (NP).

The aforementioned song rearrangement and player software program (F), consists of a authentication module (F1) which allows the consumer end (10), vis a vis a authentication system (X), access to said software program (F) and/or to sign in and gain entry into the service platform (100)

It also consists of an encryption storage module (F), connected to the authentication module (F1), which allows a presegmented song which had been retrieved to be stored in a distant location.

It also consists of an application module (F3), connected to both the authentication module (F1) and the encryption storage module (F2), that allows the consumer end (10) to proceed with rearrangement and replay of the presegmented song (P).

It also consists of a song purchasing module (F4), connected to both the authentication module (F1) and the encryption storage module (F2), that provides the consumer end (1), after it has gained entry into the service platform (100), to connect with the first and second database, so that the presegmented songs (P) can be retrieved and purchased.

Through the authentication module (F1), the encrypted storage module (F2), the application module (F3), and the song purchasing module (F4), the user is given the power of song rearrangement, song replay, and song purchasing, with a user-friendliness that expands the user age. Through the encrypted storage module (F2), there are no risks in purchasing the songs and the interests of the user are protected.

The aforementioned service platform (100) consists of a remotely established independent computer server or a computer server that has massive storage space.

This gives the service platform (100) a hardware medium allowing for easy and convenient manageability.

The information exchange (M) mentioned above occurs consists of information data (M1) being sent from the consumer end (10), a song purchase information data (M2) sent from the consumer end (10), payment information data (M3) sent from the consumer end (10), sign-in information data (M4) sent from the consumer end (10), and a sign-off information data (M5) sent from the consumer end (10).

Having distinct information data (M) makes for accuracy in the operation, thus achieving a desirable standard of service.

As to the authentication system (X), it consists of a hardware authentication device, and it also consists of a connection medium (X1) that can be connected to the consumer end (10); and an encrypted storage area (X3) and another storage (X4), electronically connected to the aforementioned connection medium (X1), which can be connected to the song rearrangement and replay program (F) so as to provide access by the consumer end (1) to the main body (X2) used by the song rearrangement and replay program (F).

Through the application of the authentication system (X) and the connection of the connection medium (X1) to the consumer end (1), the consumer will find the setup convenient to use. Through the encrypted account number storage area (X3) and use of the other storage area (X4), there is none of the problems regarding forgotten account number or forgotten location of the downloaded presegmented songs (P). While reducing the hassle of the consumer, it, most importantly, fully protects the property rights of the author of the presegmented songs (P) so as to not discourage song writing.

Furthermore, when the authentication system (X) is based on a hardware authentication device, because each verification system (X) represents one single unique account, with the interplay with the second database (2), even if the account is hacked, the second database (2) will continue to manage a single unique account so that multiple users using a single account is avoided. This is different from the conventional online music purchase systems. Not only does the merchant have little to gain, or the music, very difficult to pirate, also, even if there is not internet connection, one can be assured that the presegmented songs (P) would not be pirated.

Moreover, by establishing the encrypted account storage area (X3), the degree of difficulty for hackers is substantially increased.

As to the connection medium (X1) mentioned before, it can be one of the following: USB, Mini USB, Micro USB, and Thunderbolt.

This features provides different connection mediums (X1) so as to meet the needs of the consumer end (10), thereby allowing more consumers to use this invention, and at the same time, expanding the scope of application of the authentication system (X).

As to the additional storage area (X4), stored inside it are a song rearrangement and reply program (F), and the presegmented song (P) that the consumer end (10) had purchased.

Through the use of this storage area (X4), aside from accomplishing the aforesaid problem of trying to locate a downloaded sound file (P), it also saves the step of downloading a song. When the song rearrangement and replay program is installed (F), it can be readily used at any time, which is convenient for use during worship services.

The presegmented songs (P) comprise of one or more of the following: the main verse (P1) of the original song (NP), the chorus (P2), the interlude (P3), the free worship portion of the song (P4), and the postlude (P5).

Different original songs (NP) feature different song structures. Thus, a vast array of presegmented songs (P) will be provided, increasing the choices of the user, so that the songs provided by this invention will be distinct from the traditional gospel songs.

The authentication system (X) mentioned previously is a encrypted account number authentication system.

Through this authentication system, although the protection of the song author's property rights will be lower than that of a hardware authentication system, but it can reduce the user's difficulties in using the application, thus benefitting the supplier's attempt at expanding the spread of this invention.

The description set forth above reveals that this invention, through the interplay between a song rearrangement and replay program (F) and the service platform (100), conveniently allows the user to perform modification of presegmented songs (P), so as to fit the realistic needs of the consumers, and with the authentication system (X) in place, also protects the song author's property rights more than the traditional on-line song purchase systems, and in fact, features more applications, pragmatic features, functionality, and product usefulness.

The structure, characteristics, and function of this invention, as described above, can be illustrated through the diagram provided. To meet the requirements of novelty and improvements, the instant application is submitted in accordance with the law. The aforementioned description are the most representative in describing the function of this invention but certainly are not exhaustive. Thus, any variation of the description that is in accord with the invention, so long as it is within the realm of the above description, should all be included within the scope of this invention.

### BRIEF DESCRIPTION OF THE DRAWINGS

FIG. 1: The diagram illustrating the invention

FIG. 2: Diagram illustrating the relation between the original song and presegmented song.

FIG. 3: Diagram illustrating the song rearrangement and reply program

FIG. 4: Diagram illustrating the detailed components of the consumer end when it is connected to the service platform.

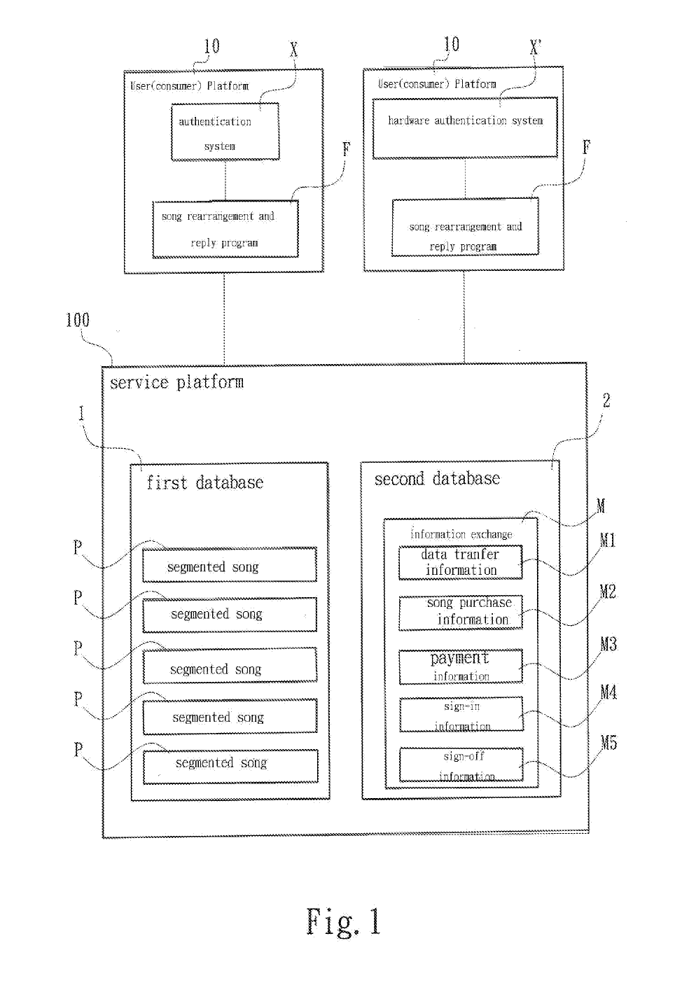

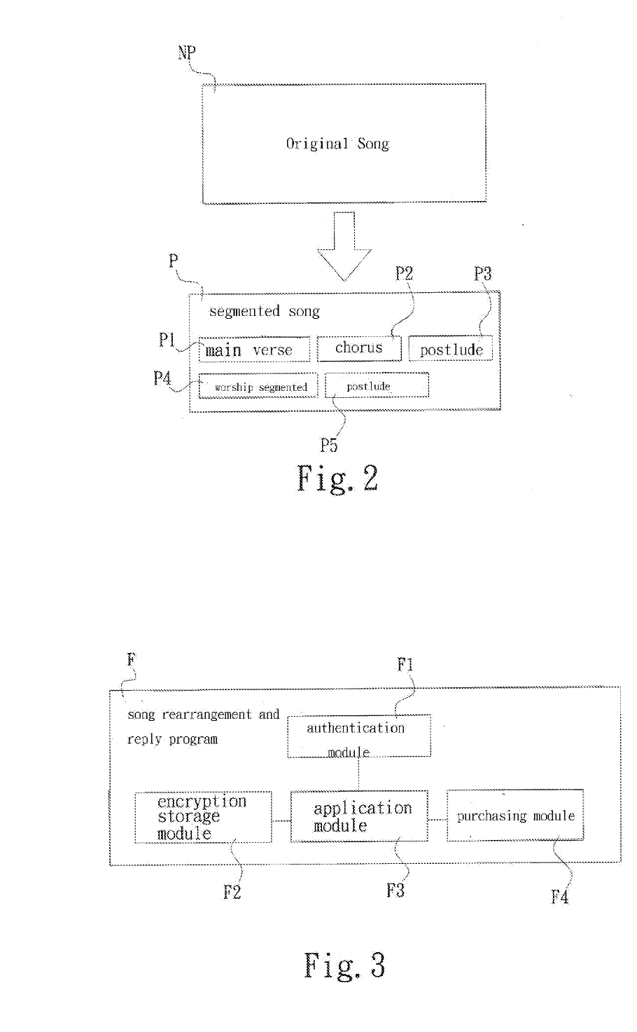

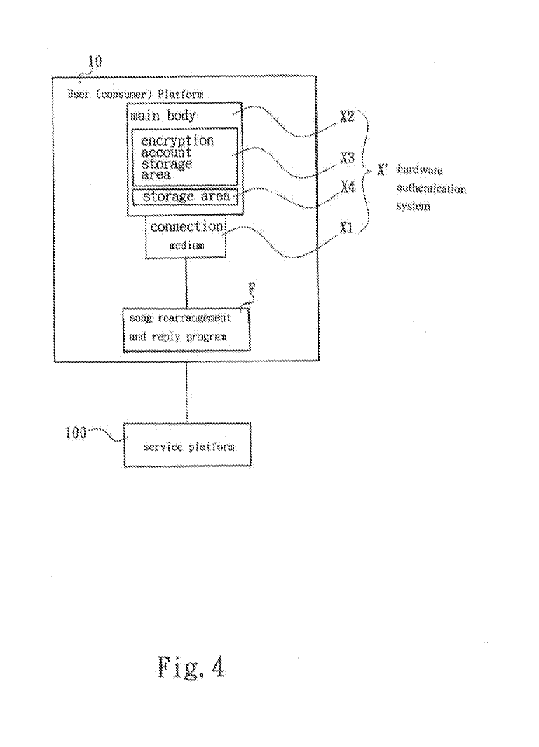

What is claim is:

1. A gospel song rearrangement and reply platform, that includes:
A remotely located service platform (100) which contains numerous original gospel songs (NP) and these gospel songs in their segmented form (P), which platform supplies a song rearrangement and reply software program (F) to the consumer (10) through sign-in access.
The characteristic lies in:
The service platform (100), comprises of numerous remotely stored presegmented songs (P), which at the appropriate time, can supply a song rearrangement and replay program (F) to the consumer end (1), and allow the consumer end (10), through said program (F), to sign in, purchase, and retrieve the first database (1) containing at least one presegmented song (P); and a second database (2), which is connected with the first database (1), that can manage information data exchange (M) with the consumer end (10);
The consumer end (10) uses an authentication system (X) that triggers the song rearrangement and replay program (F) and or gains access into the applications inside the service platform (100).

2. A gospel song rearrangement and reply platform according to claim 1 is characteristic in that: as to the aforementioned song rearrangement and replay program (F), the consumer end (10), through use of the authentication system (X), either triggers the use of this program (F) or the authentication module (F1) used during the sign-in access into the service platform (100).
An encrypted storage module (F2), which is connected to said authentication module (F1), that can allow the presegmented songs (P) to be stored in a different location.
An application module (F3) which is connected to both the authentication module (F1) and the encrypted storage module (F2), which can provide the consumer end (10) the ability to proceed with the rearrangement and reply of the presegmented songs (P); and a song purchase module (F4) which is connected to both the authentication module (F1) and the encrypted storage module (F2), which provides the consumer end (10), after it has signed-in into the service platform (1000), access the first database (1) and the second database (2), so that the purchase and retrieval of a presegmented song (P) can proceed.

3. A gospel song rearrangement and reply platform according to claim 1 is characteristic in that: the service platform (100) is located in a remote end in one of the following: an independent computer server or a computer server with a large scale storage room.

4. A gospel song rearrangement and reply platform according to claim 1 is characteristic in that: the aforementioned information data exchange (M) includes at least the information data transmittal (M1) of at least one consumer end (10), the purchasing data (M2) from at least one consumer end (10), the payment data (M3) from at least one consumer end (10), the sign-in data (M4) from at least one consumer end (10), and the sign-off data (M5) from at least one consumer end (10).

5. As is required, the special characteristic of the above-described gospel song rearrangement and replay platform lies in: the authentication system (X) previously mentioned is a hardware authentication device that also includes a connection medium (X1) that can connected with the consumer end (10); and
A main body (X2) which is electronically connected with the connection medium (X1) and which features an encrypted account number storage area (X3) and another storage area (X4), which can be connected to the song rearrangement and reply program (F), so as to provide the consumer end (10) with use of said program (F).

6. A gospel song rearrangement and reply platform according to claim 5 is characteristic in that: a special characteristic of the above-described gospel song rearrangement and replay platform lies in: the connection medium previously mentioned (X1) can be any one of the following: USB, Mini USB, Micro USB, or Thunderbolt.

7. A gospel song rearrangement and reply platform according to claim 5 is characteristic in that: within the previously described storage area (X4) is stored a song rearrangement and replay program (F) and the presegmented song (P) that the consumer end (10) had purchased.

8. A gospel song rearrangement and reply platform according to claim 5 is characteristic in that: the presegmented song (P) is a combination of any number of the following: (1) the main verse (P1) of the original song (NP), the chorus (P2) of the original song (NP), the interlude (P3) of the original song (NP), the free worship part (P4) of the original song (NP), and the postlude (P5) of the original song (NP).

9. A gospel song rearrangement and reply platform according to claim 5 is characteristic in that: the previously-described authentication system (X) is an encrypted account number authentication system.
